(19) United States
(12) Patent Application Publication
(10) Pub. No.: US 2012/0165989 A1
(43) Pub. Date: Jun. 28, 2012

(54) SYSTEM AND METHOD FOR MANAGING BUILDING FACILITIES AND DEFECTS THEREOF

(75) Inventors: Jinsoo HAN, Daejeon (KR); Chang-Sic Choi, Daejeon (KR); Wan Ki Park, Daejeon (KR); Youn Kwae Jeong, Daejeon (KR); Il Woo Lee, Daejeon (KR)

(73) Assignee: Electronics and Telecommunications Research Institute, Daejeon (KR)

(21) Appl. No.: 13/334,492

(22) Filed: Dec. 22, 2011

(30) Foreign Application Priority Data
Dec. 23, 2010 (KR) 10-2010-0133901

(51) Int. Cl. G05B 15/00

(52) U.S. Cl. 700/275

(57) ABSTRACT

A system for maintaining building facilities includes: a building status management engine for monitoring status and environment of a building, and outputting data accumulated through the monitoring or a control instruction generated based on the data accumulated through the monitoring; a building facilities association database for storing information on association between the building facilities; a facility control instruction input unit for receiving a facility control instruction as an input; and a building facility controller for controlling a building facility installed in the building, and, determining effect thereof on building facilities using the building facilities association database.

### CROSS-REFERENCE(S) TO RELATED APPLICATION(S)

The present invention claims priority of Korean Patent Application No. 10-2010-0133901, filed on Dec. 23, 2010, which is incorporated herein by reference.

### FIELD OF THE INVENTION

The present invention relates to a system for managing building facilities, and, more specifically, to a method and system for managing building facilities and defects thereof in a building where a building automation system (BAS) and/or a building energy management system (BEMS) are installed.

### BACKGROUND OF THE INVENTION

In managing a building with BAS and/or BEMS, it is necessary to keep the building facilities in their best condition and quickly handle a possible defect in the facilities.

Conventionally, a periodic building commissioning process is adopted to maintain the normal operation of a building, for which a building manager stays in the building and, when an alarm occurs for a specific facility in the building, controls the facility according to a predefined manual for such alarm.

Although such commissioning process may help maintaining a building, it is preferred to have an advanced process for maintaining a building in more effective and predictive way.

As modern building grows bigger and more complex, the number of facilities and sensors installed in a building is increasing. According, it is difficult to control and manage the building facilities with such complex structure solely based on managers' or engineers' experiences. For example, when the number of facilities is large, the facilities are associated with one another in a complex way so that a change in a facility may cause certain change in other facilities, resulting in unexpected situation in the entire building. However, there has been no process proposed for managing the building facilities in consideration of the association between the facilities.

### SUMMARY OF THE INVENTION

In view of the above, the present invention provides a system and method for managing building facilities and defects thereof, which can maintain and manage a BAS and/or BEMS installed in a building by monitoring status and environment of a building and accumulating data through such monitoring. The system and method may determine whether that performance of any of the building facilities is deteriorated or degraded by comparing the current monitoring result with the accumulated data.

Further, the present invention provides a system and method for managing building facilities and defects thereof, which can control, when any deterioration or the like is determined, the building facilities in consideration of the association between the facilities to prevent a possible emergency situation.

Further, the present invention provides a system and method for managing building facilities and defects thereof, which is capable of establishing a database for the association between the building facilities that can be used for determining whether any change in staff of the building or any control instruction causes a hazardous situation in the building. For example, the effect of aging or deterioration of one or more facilities on the building is determined and notified to a budding manager so that the manager can take a necessary measure. In one embodiment, the effect of a control instruction, which is generated in the system or is inputted by a manager, on the building is determined before actually implementing the control instruction.

In accordance with a first aspect of the present invention, there is provided a system for managing building facilities and defects thereof, including:

a building status management engine for receiving building status management information to monitor status and environment of a building, and outputting data accumulated through said monitoring or a control instruction generated based on said data accumulated through said monitoring;

a building facilities association database for storing information on association between the building facilities;

a facility control instruction input unit for receiving a facility control instruction as an input; and

a building facility controller for controlling a building facility installed in the building, and, upon receiving at least one of said data, said control instruction and said facility control instruction, determining effect thereof on building facilities using said building facilities association database.

In accordance with a second aspect of the present invention, there is provided a method for managing building facilities and defects thereof, including:

monitoring status and environment of a building based on building status management information received from a facility control instruction input unit;

outputting data accumulated through said monitoring or a control instruction generated based on said data accumulated through said monitoring;

determining, in a building facility controller, effect of at least one of said data, said control instruction and said facility control instruction on building facilities using a building facilities association database, the building facilities association database storing information on association between the building facilities; and

controlling a building facility installed in the building based on said data or said control instruction.

### BRIEF DESCRIPTION OF THE DRAWINGS

The objects and features of the present invention will become apparent from the following description of embodiments, given in conjunction with the accompanying drawings, in which:

FIG. 1 shows a block diagram illustrating a system for managing building facilities and defects thereof in accordance with one embodiment of the present invention;

FIG. 2 shows a block diagram illustrating a system for managing building facilities and defects thereof, having a communication unit, in accordance with another embodiment of the present invention;

FIG. 3 shows a flow chart explaining an operation of a system for managing building facilities and defects thereof, in accordance with one embodiment of the present invention; and

FIG. 4 shows a flow chart explaining an operation of a system for managing building facilities and defects thereof, having a communication unit, in accordance with one embodiment of the present invention.

### DETAILED DESCRIPTION OF THE EMBODIMENTS

In accordance with one embodiment of the present invention, there is provided a system and method for maintaining BAS and/or BEMS installed in a building, wherein the status of the building facilities are monitored and the monitored status are accumulated and maintained. When a defect in the facilities is detected, the status of the facilities is compared with the maintained status to determine whether the facilities have been deteriorated.

When the status of the facilities changes abruptly, such change is handled in consideration of the association between the building facilities in order to prevent an emergency.

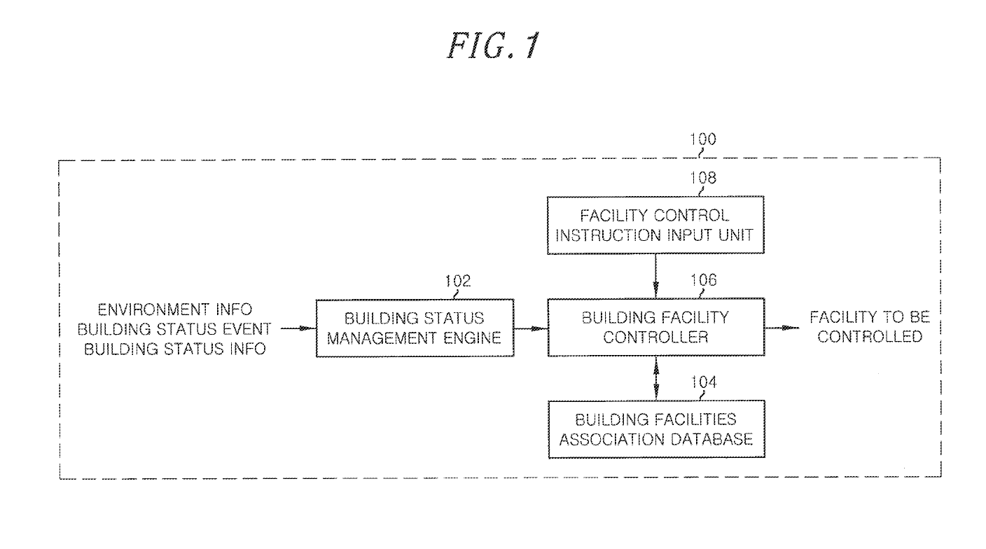

FIG. 1 shows a block diagram illustrating a system for managing building facilities and defects thereof in accordance with one embodiment of the present invention.

Referring to FIG. 1, the system 100 of the embodiment includes a building status management engine 102 for receiving building status management information, which includes at least one of a building status event, information on environment in and around the building and information on status of the building facilities, and managing the environment and status of the building. The system 100 also includes a building facilities association database 104 configured to provide information on association between the building facilities, a building facility controller 106 for controlling a building facility installed in the building, and, a facility control instruction input unit 108 for receiving a facility control instruction as an input from a building manager and sending the facility control instruction to the building facility controller 106.

When the building status management engine 102 receives information about at least one of a building status event, environment (e.g, weather, temperature, humidity, quality of the air, and the like.) in and around the building and status of the building facilities, the building status management engine 102 monitors such information and stores the result of monitoring in a storage (not shown) within the engine 102.

Based on the received information, the building status management engine 102 may determine in which way the building facilities are controlled, and accordingly send instruction(s) to the building facility controller 106.

In other words, the building status management engine 102 may process event(s) and alarm(s) occurred in the building and constantly accumulate the received information. Further, the building status management engine 102 may also periodically monitor the status of the building facilities and accumulate the monitoring result. So it is possible to track the status of the building facilities and determine whether there is a defect in the building facilities.

The building facilities association database 104 stores the information on the association between the building facilities. The information may include the effect of a change in a facility on the other facilities, and secondary and/or tertiary effect of a change in a facility which propagates to the other facilities.

From the building facilities association database 104, it is possible to understand what will happen to the building facilities when one of the facilities in the building ages or its performance deviates from a certain standard based on the association information. Accordingly, it may be tracked back based on the change in the status of the building facilities which facility among the building facilities causes such change.

Further, when a building manger intends to take an emergency measure in response to a defect occurred in the facilities or controls a facilities that caused such defect, a search of the building facilities association database 104 may provide information about any possible dangerous effect that such measure or control will result in on the building facilities.

The building facilities association database 104 may be updated based on control by the building facility controller or an input from a building manger when a change in the association between facilities occurs. The change in the association may be caused by at least one of an addition of a facility to the building, a change in one or more of the building facilities, an uninstallation of one or more of the building facilities, and a change in the environment of the building.

The building facility controller 106 may control each of the units or functional blocks of the system. The building facility controller 106 may determine which facility or facilities it should control based on the instruction received from the building status management engine 102. Before the building facility controller 106 performs control, it may consult the building facilities association database 104 to verify that its control will not adversely affect the other facilities.

If the verification result is positive (i.e., the control will not adversely affect the building), the building facility controller 106 performs its intended control. However, if the control is predicted to have any adverse effect on the building, the building facility controller 106 may postpone the performance of such control, and display the adversary effect on a display so that a building manager can see it. In one embodiment, when the building status management engine 102 sends a emergency instruction to the building facility controller 106 for a quick response to a defect in the facilities, the building manager may be notified of whether such emergency instruction is allowable. Accordingly, the building manager may take an additional action to handle the defect.

In one embodiment, the building status management engine 102 accumulates the information about at least one of a building status event, environment in and around the building and status of the building facilities, and monitors the status of the building facilities. When a deterioration of the performance of a particular facility is detected, the building status management engine 102 may notify the building facility controller 106 thereof. In this embodiment, the building facility controller 106 helps the building manager with his/her management by notifying that the particular facility is likely to have a defect or problem.

The building facility controller 106 may determine which of the building facilities is malfunctioning or is in deterioration in its performance based on the building status information which, in one example, the building status management engine 102 provides periodically, by consulting the data stored in the building association database 104. For example, when information indicating a defect or a problem in the building facilities is received, the building facility controller 106 may looks up the association between the facilities stored in the data 104 to track back a particular facility that is suspected to cause the problem. Note that the building status engine 102 need not notify the building facility controller 106 that a particular facility is suspected to have a problem. The building facility controller may then notify the building manager of the suspect facility.

The facility control instruction input unit 108 may allow a building manager to enter a control instruction to the building facility controller 106, for example, if he/she wants to control the building facilities directly. In one embodiment, when a control instruction is entered via the facility control instruction input unit 108, the building facility controller 106 may consult the facilities association database 104 to understand possible effect(s) on the building facilities, which will arise when such instruction is implemented. If any adversary effect is predicted, the controller 106 may notify the building manager of the predicted adverse effect so that he can take alternative and/or additional measure. Otherwise, the controller 106 implements the instruction as entered.

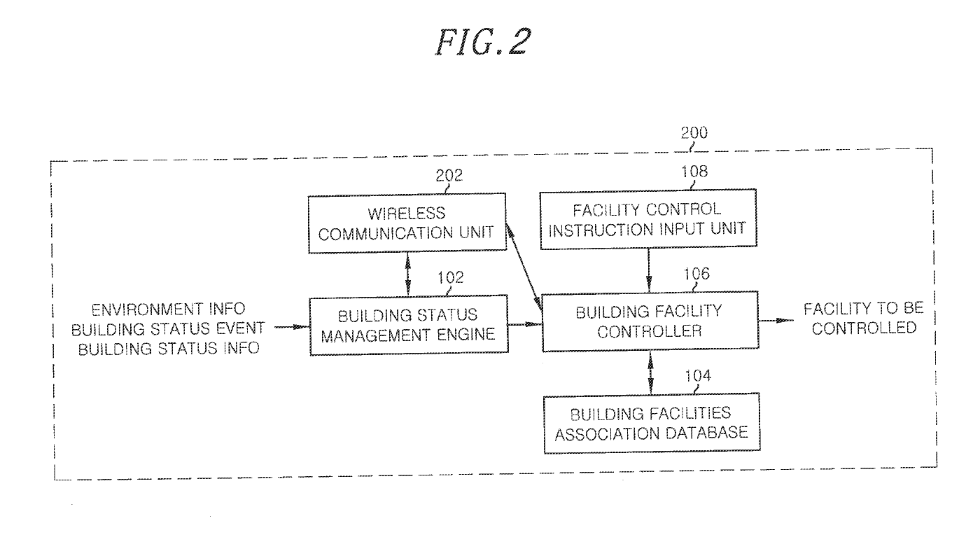

FIG. 2 shows a block diagram illustrating a system for managing building facilities and defects thereof, having a communication unit, in accordance with another embodiment of the present invention.

Referring to FIG. 2, the system 200 of this embodiment includes a communication unit 202, in addition to the building status management engine 102, the building facilities association database 104, the building facility controller 106, and the facility control instruction input unit 108.

In one embodiment, it is possible that a building is maintained from a remote place. For example, an expert system, which is operated by a number of building management experts, may maintain one or more building from a separate or remote place. In this case, the communication unit 202 enables the expert system located at a remote place to communicate with the building facility controller 106. The use of expert system may be more efficient because the experts have accumulated knowledge and/or know-how which has been obtained from managing a number of buildings.

In one embodiment, the communication unit 202 remotely connects the building facility controller 106 and the expert system so that the expert system may receive the information on the building from the building status management engine 102, for example, via the controller 106 and the communication unit 202. Based on the received information, the expert system may send control instruction(s) to the building facility controller 106, for example, to minimize or reduce the energy consumption in the building.

Before implementing the instruction from the expert system, the building facility controller 106 may consult the facilities association database 104 to understand possible effect(s) on the building facilities, which will arise when such instruction is implemented. If no adversary effect is predicted, the controller 106 implements the instruction and notifies the expert system of the result of such implementation.

However, if any adversary effect is predicted, the controller 106 may postpone the implementation and notify the expert system of such adverse effect via the communication unit 202. Accordingly, the expert system can take alternative and/or additional measure, and accumulate knowledge which can be used for better management of the building or other buildings.

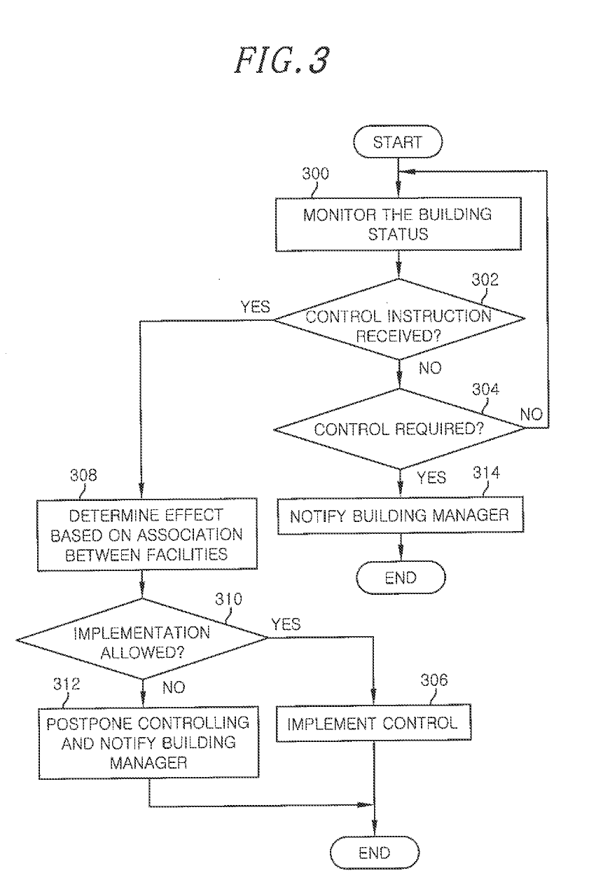

FIG. 3 shows a flow chart explaining an operation of a system for managing building facilities and defects thereof in accordance with one embodiment of the present invention.

Referring to FIG. 3, in accordance with an embodiment of the present invention, the building status management engine 102 of the system 100 monitors status and environment of a building based on building status management information in step 300. The building status management information may include at least one of information on a building status event, information on environment in and around the building and information on status of the building facilities. The engine 102 may perform such monitoring in a periodic basis.

The building status management engine 102 may then send to the building facility controller 106 data accumulated through such monitoring or a control instruction generated based on the accumulated data. The control instruction may indicate how one or more facilities in the building should be controlled.

Upon receiving the data or the control instruction, the building facility controller 106 determines whether a control instruction is received through the facility control instruction input unit 108 in step 302. The control instruction may be received from the facility control instruction input unit 108 and/or the facility status management engine 102.

If not, the controller 106 accesses the facilities association database 104 to check whether the received information indicates that any of the building facilities needs to be controlled in step 304. This may be done by checking whether the change in status of the facilities or the environment will result in any adversary effect on the building facilities. If there is no need to control the facilities, the process proceeds to step 300 and waits for new information. If the controller 106 determines that the building facilities needs to be controlled, the building facility controller 106 notifies the building manager of such need by outputting alarm sound, displaying the information, and the like in step 314.

If a control instruction is received in step 302, the controller 106 may consult the database 104 in step 308 to determine whether the implementation of the received control instruction will result in any adversary effect on the building facilities in step 310.

If it is assured that the control instruction will not cause an adversary effect (Yes in step 310), the building facility controller 106 implements the instruction in step 306. For example, the building facility controller 106 sends the control instruction or a converted version of such instruction to a particular facility that has the reduced/deteriorated performance.

Otherwise (No in step 310), the controller 106 may postpone the implementation of the control instruction and notify the building manager of the adversary effect of the control instruction in step 312. Then the building manager can take an alternative/additional measure to prevent or avoid such adversary effect, and the system will continue to monitor the status and environment.

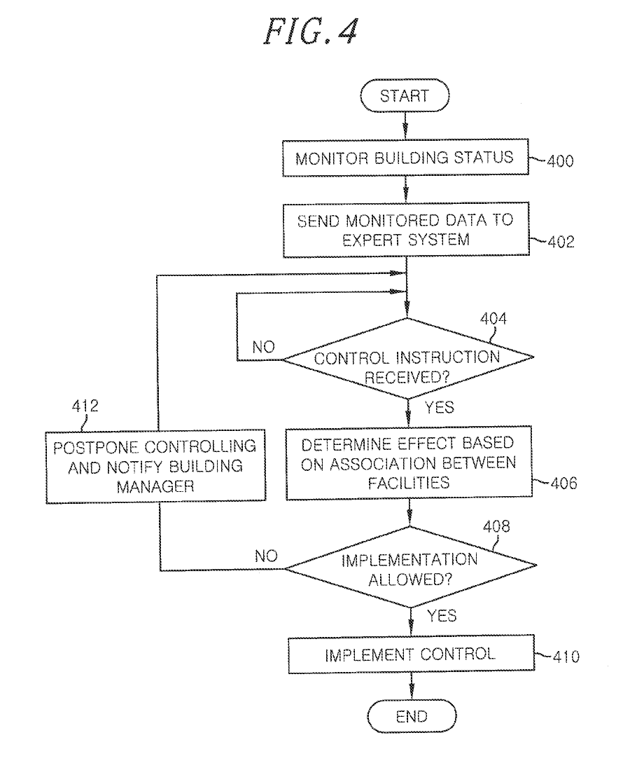

FIG. 4 shows a flow chart explaining an operation of a system for managing building facilities and defects thereof, having a communication unit, in accordance with one embodiment of the present invention.

Referring to FIG. 4, in accordance with an embodiment of the present invention, the building status management engine 102 of the system 100 monitors status and environment of a building based on building status management information in step 400. The building status management information may include at least one of information on a building status event, information on environment in and around the building and information on status of the building facilities. The engine 102 may perform such monitoring in a periodic basis.

The building status management engine 102 may then send data accumulated through such monitoring to the expert system via the communication unit 202 in step 402.

In step 404, the building facility controller 106 determines whether a control instruction is received from the expert system.

If a control instruction is determined to be received, the controller 106 may consult the database 104 in step 406 to determine whether the implementation of the received control instruction will result in any adversary effect on the building facilities in step 408.

If it is assured that the control instruction will not cause an adversary effect (Yes in step 408), the building facility controller 106 implements the instruction from the expert system in step 410.

Otherwise (No in step 408), the controller 106 may postpone the implementation of the control instruction and notify the expert system of the adversary effect of the control instruction in step 412. Then the expert system can take an alternative/additional measure to prevent or avoid such adversary effect, and the system will continue to monitor the status and environment.

As described above, in accordance with the embodiments of the present invention, the system and method for managing building facilities and defects thereof maintains and manages a BAS and/or BEMS installed in a building by monitoring status and environment of a building and accumulating data through such monitoring. The system and method determines whether that performance of any of the building facilities is deteriorated or reduced by comparing the current monitoring result with the accumulated data.

When any deterioration or reduce is determined, the system and method controls the building facilities in consideration of the association between the facilities to prevent a possible emergency situation.

The present invention achieves one or more of the below advantageous effect.

In accordance with one embodiment, a building manager can efficiently manages a building to prevent the malfunction of the building by tracking back any facility in the building that is aged or deteriorated based on the association between the facilities and notifying the building manger thereof.

Further, when a building manager wants to control any of the building facility, a possible adversary effect of the control on the building facilities may be predicted using the facilities association database so that the manager can avoid a control that has adversary effects on the building.

When the building facilities are controlled based on the information on the building status event, environment and/or status of the facilities, the facilities association database is used to predict a possible effect of the control on the building facilities to postpone or implement the control.

When expert system controls a building, the control instructions from the expert system are checked using the facilities association database, and the expert system is notified as to whether the instruction results in adversary effect on the building facilities. This allows the expert system to accumulate more knowledge about the building and the management.

While the invention has been shown and described with respect to the embodiments, it will be understood by those skilled in the art that various changes and modification may be made without departing from the scope of the invention as defined in the following claims.

What is claimed is:

1. A system for managing building facilities and defects thereof, comprising:
a building status management engine for receiving building status management information to monitor status and environment of a building, and outputting data accumulated through said monitoring or a control instruction generated based on said data accumulated through said monitoring;
a building facilities association database for storing information on association between the building facilities;
a facility control instruction input unit for receiving a facility control instruction as an input; and
a building facility controller for controlling a building facility installed in the building, and, upon receiving at least one of said data, said control instruction and said facility control instruction, determining effect thereof on building facilities using said building facilities association database.

2. The system of claim 1, wherein the building facility controller controls the building facility based on said control instructions when said determined effect is smaller than a predetermined threshold.

3. The system of claim 1, wherein the building facility controller postpones controlling the building facility based on said control instructions when said determined effect is greater than a predetermined threshold, and notifies a building manager of said postponing.

4. The system of claim 1, wherein the building status management information includes information about at least one of a building status event, environment in and around the building and status of the building facilities.

5. The system of claim 1, wherein said information on association between the building facilities includes information on a direct effect and/or an indirect effect of a change in a building facility on other building facilities.

6. The system of claim 1, wherein when a change in the association between the building facilities is detected, the building facilities association database is updated based on control by the building facility controller or input information on said detection, said change in the association is caused by at least one of an addition of a facility to the building, a change in one or more of the building facilities, an uninstallation of one or more of the building facilities, and a change in the environment of the building.

7. The system of claim 1, further comprising:
a communication unit for receiving said data from the building status management engine, forwarding said data to expert system which is located in a remote place, and sending to the building facility controller a facility control instruction which is received from the expert system.

8. A method of managing building facilities and defects thereof, comprising:
monitoring status and environment of a building based on building status management information received from a facility control instruction input unit;
outputting data accumulated through said monitoring or a control instruction generated based on said data accumulated through said monitoring;
determining, in a building facility controller, effect of at least one of said data, said control instruction and said facility control instruction on building facilities using a building facilities association database, the building facilities association database storing information on association between the building facilities; and
controlling a building facility installed in the building based on said data or said control instruction.

9. The method of claim 8, wherein said determining includes determining said effect based on control instruction received from the facility control instruction input unit.

10. The method of claim 8, wherein said controlling includes controlling the building facility based on said control instructions when said determined effect is smaller than a predetermined threshold.

11. The method of claim 8, wherein said controlling includes postponing controlling the building facility based on said control instructions when said determined effect is greater than a predetermined threshold, and notifying a building manager of said postponing.

12. The method of claim 8, wherein the building status management information includes information about at least one of a building status event, environment in and around the building and status of the building facilities.

13. The method of claim 8, wherein said information on association between the building facilities includes information on a direct effect and/or an indirect effect of a change in a building facility on other building facilities.

14. The method of claim 8, wherein when a change in the association between the building facilities is detected, the building facilities association database is updated based on control by the building facility controller or input information on said detection, said change in the association is caused by at least one of an addition of a facility to the building, a change in one or more of the building facilities, an uninstallation of one or more of the building facilities, and a change in the environment of the building.

15. The method of claim 8, further comprising:
Receiving, via a communication unit, said data from the building status management engine and forwarding said data to expert system which is located in a remote place; and
sending to the building facility controller a facility control instruction which is received from the expert system.

16. The method of claim 15, wherein said controlling includes postponing controlling the building facility based on said control instructions when said determined effect is greater than a predetermined threshold, and notifying a building manager of said postponing.
